(19) United States
(12) Patent Application Publication
(10) Pub. No.: US 2015/0044763 A1
(43) Pub. Date: Feb. 12, 2015

(54) FRET MEASUREMENT DEVICE AND FRET MEASUREMENT METHOD

(71) Applicants: Mitsui Engineering & Shipbuilding Co., Ltd., Chuo-ku, Tokyo (JP); NATIONAL UNIVERSITY CORPORATION HOKKAIDO UNIVERSITY, Sapporo-shi, Hokkaido (JP)

(72) Inventors: Shigeyuki Nakada, Tamano-shi (JP); Yusuke Ohba, Sapporo-shi (JP); Kyouji Doi, Tamano-shi (JP); Yumi Asano, Tamano-shi (JP)

(73) Assignees: Mitsui Engineering & Shipbuilding Co., Ltd., Chuo-ku, Tokyo (JP); NATIONAL UNIVERSITY CORPORATION HOKKAIDO UNIVERSITY, Sapporo-shi, Hokkaido (JP)

(21) Appl. No.: 14/381,904

(22) PCT Filed: Mar. 22, 2013
(86) PCT No.: PCT/JP2013/058317

§ 371 Date: Aug. 28, 2014

(30) Foreign Application Priority Data
Mar. 22, 2012 (JP) 2012-065769

(51) Int. Cl. G01N 21/64

(52) U.S. Cl. CPC G01N 21/6486; G01N 2201/06113; G06F 19/18
USPC 435/288.7; 702/19

(57) ABSTRACT

FRET measurement uses a FRET probe that includes a probe element X labeled with a donor fluorescent substance and a probe element Y labeled with an acceptor fluorescent substance and enables FRET to occur when the probe element X and the probe element Y approach to each other or bind together. A test sample as a measuring object in FRET measurement contains a test object about which it is unknown whether or not it has an approaching/binding property of allowing the probe element X and the probe element Y to approach to each other or bind together or a separating property of separating from each other the probe element X and the probe element Y that are in a state where they adjoin each other or bind together. A plurality of sets of a fluorescence lifetime τₛₐₘₚₗₑ and a ratiometry Rₛₐₘₚₗₑ obtained by this measurement are used to judge whether or not the test object has the approaching/binding property or the separating property.

### TECHNICAL FIELD

The present invention relates to a device and method for measuring FRET using a FRET probe that includes a probe element X containing a donor fluorescent substance and a probe element Y containing an acceptor fluorescent substance and that enables FRET to occur when the probe element X and the probe element Y approach to each other or bind together. FRET refers to fluorescence resonance energy transfer.

### BACKGROUND ART

At present, functional analysis of proteins has become important as post-genome-related technology in medical care, drug development, and food industry. Particularly, in order to analyze cellular action, it is necessary to investigate interaction (binding, separation) between a protein as a biological substance and another protein or a low-molecular compound in a living cell.

The interaction between a protein as a biological substance and another protein or a low-molecular compound in a living cell is analyzed by utilizing a fluorescence resonance energy transfer (FRET) phenomenon. Interaction between molecules in a region of several nanometers can be measured by measuring fluorescence generated by the FRET phenomenon. FRET refers to a phenomenon in which, when a donor fluorescent substance is excited by laser light irradiation, part of excitation energy is transferred to an acceptor fluorescent substance located close to the donor fluorescent substance without emitting fluorescence so that the acceptor fluorescent substance emits fluorescence.

When the presence or absence of the occurrence of FRET is investigated by giving a fluorescent substance to a biological substance such as a protein, a method is conventionally used in which the presence or absence of the occurrence of FRET is investigated based on a change in the intensity of fluorescence emitted from the fluorescent substance. More specifically, this method measures the decrement of the fluorescence intensity of donor fluorescence emitted from a donor fluorescent substance due to the transfer of part of excitation energy from the donor fluorescent substance and the increment of fluorescence intensity due to emission of acceptor fluorescence from an acceptor fluorescent substance using the transferred excitation energy. However, this method cannot always accurately judge the presence or absence of the occurrence of FRET because the decrement and the increment vary depending on the amount of the donor fluorescent substance or the acceptor fluorescent substance (label) contained in a measuring object.

On the other hand, as a method less likely to be influenced by the amount of a label, such as a donor fluorescent substance or an acceptor fluorescent substance, contained in a measuring object such as a biological cell, a method is known in which the fluorescence lifetime of donor fluorescence emitted from a donor fluorescent substance is measured, and the presence or absence of the occurrence of FRET is judged based on a change in the fluorescence lifetime (Patent Literature 1).

### CITATION LIST

### Patent Literature

Patent Literature 1: JP 2007-240424 A

### SUMMARY OF INVENTION

### Technical Problem

The above method can more accurately judge the presence or absence of the occurrence of FRET by using a change in fluorescence lifetime as well as the decrement of the fluorescence intensity of donor fluorescence and the increment of the fluorescence intensity of acceptor fluorescence. When the donor fluorescent substance emits one kind of donor fluorescence (fluorescence lifetimes are the same), the method can accurately detect a change in fluorescence lifetime and therefore can judge the presence or absence of the occurrence of FRET. However, when the donor fluorescent substance emits donor fluorescence containing a plurality of fluorescent components different in fluorescence lifetime, the method sometimes cannot accurately judge the presence or absence of the occurrence of FRET. Particularly, when a biological substance or the like is an object to be measured, a fluorescent protein is used as a label such as a donor fluorescent substance or an acceptor fluorescent substance. However, some fluorescent proteins emit a plurality of fluorescent components (a plurality of components different in fluorescence lifetime), and therefore the method sometimes cannot accurately judge the presence or absence of the occurrence of FRET when a fluorescent protein is used as a donor fluorescent substance. Therefore, it is also difficult to accurately understand the property of a test object, such as a drug, contained in a measuring object, such as a biological cell, from the result of FRET measurement.

It is therefore an object of the present invention to provide a FRET measurement device and a FRET measurement method that can accurately judge the presence or absence of the occurrence of FRET to accurately understand the property of a test object such as a drug.

### Means to Solve the Problem

An aspect of the invention is a FRET measurement device. The device includes a conduit, light source unit, a light source unit, a fluorescence calculating unit, and a judgment unit.

Through the conduit, a sample flows, the sample including a FRET probe and a test object.

The FRET probe includes a probe element X labeled with a donor fluorescent substance and a probe element Y labeled with an acceptor fluorescent substance and enables FRET to occur when the probe element X and the probe element Y approach to each other or bind together.

The test object is unknown whether or not it has an approaching/binding property of allowing the probe element X and the probe element Y to approach to each other or bind together or a separating property of separating the probe element X and the probe element Y that are in a state where they adjoin each other or bind together.

The light source unit is configured to emit, toward the conduit, laser light whose intensity is modulated using a modulation signal.

The light-receiving unit is configured to receive fluorescence emitted from the FRET probe in the sample by irradiation with the intensity-modulated laser light and outputs a fluorescent signal.

The fluorescence calculating unit is configured to calculate, using the fluorescent signal and the modulation signal, a fluorescence lifetime τₛₐₘₚₗₑ of donor fluorescence emitted from the donor fluorescent substance, and further to calculate, using the fluorescent signal, a ratio Rₛₐₘₚₗₑ of fluorescence intensity of acceptor fluorescence emitted from the acceptor fluorescent substance of the FRET probe to fluorescence intensity of donor fluorescence emitted from the donor fluorescent substance so that a plurality of sets of the fluorescence lifetime τₛₐₘₚₗₑ and the ratio Rₛₐₘₚₗₑ are calculated.

The judgment unit is configured to judge whether or not the test object has the approaching/binding property or the separating property, using the sets of the fluorescence lifetime τₛₐₘₚₗₑ and the ratio Rₛₐₘₚₗₑ.

The judgment unit is preferably configured to: set previously a first range in which the fluorescence lifetime τₛₐₘₚₗₑ and the ratio Rₛₐₘₚₗₑ can take values when the FRET occurs and a second range in which the fluorescence lifetime τₛₐₘₚₗₑ and the ratio Rₛₐₘₚₗₑ can take values when the FRET does not occur.

In this case, the judgment is configured to: extract a first set group contained in the first range from all the sets to determine a first ratio of a number of the sets of the extracted first set group to a number of all the sets; extract a second set group contained in the second range to determine a second ratio of a number of the sets of the extracted second set group to a number of all the sets; judge, using the first ratio and the second ratio, presence or absence of occurrence of the FRET; and judge whether or not the test object has the approaching/binding property or the separating property.

The judgment unit is preferably configured to: set the first range by determining a plurality of sets of a fluorescence lifetime τ_{FRET} of donor fluorescence and a ratio R_{FRET} of fluorescence intensity of acceptor fluorescence to fluorescence intensity of donor fluorescence, the fluorescence lifetime τ_{FRET} and the ratio R_{FRET} being measured through the conduit, the light source unit, the light-receiving unit, and the judgment unit, by using a positive control sample which contains the FRET probe whose probe element X and probe element Y that are allowed to approach to each other or bind together; and

set the second range by determining a plurality of sets of a fluorescence lifetime τ_{NON-FRET} of donor fluorescence and a ratio R_{NON-FRET} of fluorescence intensity of acceptor fluorescence to fluorescence intensity of donor fluorescence, the fluorescence lifetime τ_{NON-FRET} and the ratio R_{NON-FRET} being measured, through the conduit, the light source unit, the light-receiving unit, and the judgment unit, by using a negative control sample which contains the FRET probe whose probe element X and probe element Y are not allowed to approach to each other or bind together.

The judgment unit is preferably configured to: set the first range based on a regression line or regression curve showing that the ratio R_{FRET} increases as the fluorescence lifetime τ_{FRET} decreases, the regression line or regression curve being determined by performing a regression analysis or a principal component analysis on the sets of the fluorescence lifetime τ_{FRET} and the ratio R_{FRET}; and set the second range based on two averages, one of which is an average of the fluorescence lifetime τ_{NON-FRET} of the sets and the other of which is an average of the ratio R_{NON-FRET} of the sets.

The judgment unit is preferably configured to: determine a weighting coefficient for each plotted point of the fluorescence lifetime τₛₐₘₚₗₑ and the ratio Rₛₐₘₚₗₑ contained in the first set group on a scatter diagram whose horizontal axis and vertical axis represent the fluorescence lifetime τ_{FRET} and the ratio R_{FRET}, a value of the weighting coefficient increasing as a reciprocal of a shortest distance from each plotted position of the fluorescence lifetime τₛₐₘₚₗₑ and the ratio Rₛₐₘₚₗₑ contained in the first set group to the regression line or regression curve increases; and use a sum of values of the determined weighting coefficient as the number of the sets of the first set group.

Preferably, the sets of the fluorescence lifetime τₛₐₘₚₗₑ and the ratio Rₛₐₘₚₗₑ which are used for the property judgment are information selected prior to the judgment based on the fluorescence intensity of donor fluorescence and the fluorescence intensity of acceptor fluorescence.

For example, the FRET probe is incorporated into biological cells, and when receiving the fluorescence emitted from the FRET probe incorporated into the biological cells, the light-receiving unit preferably measures side-scattered light and forward-scattered light of the laser light scattered by the FRET probe to judge whether or not the biological cells incorporating the FRET probe are living cells based on a measurement result of the side-scattered light and the forward-scattered light so that only a plurality of sets of the fluorescence lifetime τₛₐₘₚₗₑ and the ratio Rₛₐₘₚₗₑ obtained from fluorescence emitted from the living cells are used for the property judgment.

Further, the judgment unit is preferably configured to: determine a plurality of quotients obtained by dividing the fluorescence intensity of donor fluorescence by the fluorescence lifetime τₛₐₘₚₗₑ of donor fluorescence to obtain a distribution of the quotients; and use, for the property judgment, a plurality of sets of the ratio Rₛₐₘₚₗₑ and the fluorescence lifetime τₛₐₘₚₗₑ determined when the quotients are contained in a preset range whose center is an average of the quotients in the distribution.

Another aspect of the invention is a FRET measurement method using a device comprising a conduit, a light source unit, a light-receiving unit, a fluorescence parameter calculating unit, and a judgment unit. The method includes the steps of:

flowing, through the conduit, a sample including a FRET probe and a test object;

causing the light source unit to emit laser light whose intensity is modulated using a modulation signal toward the conduit;

causing the light-receiving unit to receive fluorescence emitted from the FRET probe in the sample by irradiation with the intensity-modulated laser light and output a fluorescent signal;

causing the fluorescence parameter calculating unit to calculate a plurality of sets of the fluorescence lifetime τₛₐₘₚₗₑ and the ratio Rₛₐₘₚₗₑ; and

causing the judgment unit to judge whether or not the test object has the approaching/binding property or the separating property.

The FRET probe includes a probe element X labeled with a donor fluorescent substance and a probe element Y labeled with an acceptor fluorescent substance and enables FRET to occur when the probe element X and the probe element Y approach to each other or bind together.

The test object is unknown whether or not it has an approaching/binding property of allowing the probe element X and the probe element Y to approach to each other or bind together or a separating property of separating from each other the probe element X and the probe element Y that are in a state where they adjoin each other or bind together.

When the plurality of sets of the fluorescence lifetime τₛₐₘₚₗₑ and the ratio Rₛₐₘₚₗₑ is calculated, the fluorescence parameter calculating unit calculates a fluorescence lifetime τₛₐₘₚₗₑ of donor fluorescence emitted from the donor fluorescent substance and calculates, using the fluorescent signal, a ratio Rₛₐₘₚₗₑ of fluorescence intensity of acceptor fluorescence emitted from the acceptor fluorescent substance of the FRET probe to fluorescence intensity of donor fluorescence emitted from the donor fluorescent substance. Thereby, the plurality of sets of the fluorescence lifetime τₛₐₘₚₗₑ and the ratio Rₛₐₘₚₗₑ are calculated.

In the property judgment step, the judgment unit judges, using the sets of the fluorescence lifetime τₛₐₘₚₗₑ and the ratio Rₛₐₘₚₗₑ, whether or not the test object has the approaching/binding property or the separating property.

The property judging step preferably includes:

a step in which the judgment unit previously sets a first range in which the fluorescence lifetime τₛₐₘₚₗₑ and the ratio Rₛₐₘₚₗₑ can take values when the FRET occurs and a second range in which the fluorescence lifetime τₛₐₘₚₗₑ and the ratio Rₛₐₘₚₗₑ can take values when the FRET does not occur, and extracts a first set group contained in the first range from all the sets of the fluorescence lifetime τₛₐₘₚₗₑ and the ratio Rₛₐₘₚₗₑ to determine a first ratio of a number of the sets of the extracted first set group to a number of all the sets;

a step in which the judgment unit extracts a second set group contained in the second range to determine a second ratio of a number of the sets of the extracted second set group to a number of all the sets; and

a step in which the judgment unit judges, using the first ratio and the second ratio, presence or absence of occurrence of the FRET to judge whether or not the test object has the approaching/binding property or the separating property.

Then, the first range is preferably set by causing the judgment unit to determine a plurality of sets of a fluorescence lifetime τ_{FRET} of donor fluorescence and a ratio R_{FRET} of fluorescence intensity of acceptor fluorescence to fluorescence intensity of donor fluorescence, the fluorescence lifetime τ_{FRET} and the ratio R_{FRET} being measured, through the conduit, the light source unit, the light-receiving unit, and the judgment unit, by using a positive control sample, which contains the FRET probe whose probe element X and probe element Y are allowed to approach or bind together.

The second range is preferably set by determining a plurality of sets of a fluorescence lifetime τ_{NON-FRET} of donor fluorescence and a ratio R_{NON-FRET} of fluorescence intensity of acceptor fluorescence to fluorescence intensity of donor fluorescence, the fluorescence lifetime τ_{NON-FRET} and the ratio R_{NON-FRET} being measured, through the conduit, the light source unit, the light-receiving unit, and the judgment unit, by using a negative control sample which contains the FRET probe whose probe element X and probe element Y are not allowed to approach to each other or bind together.

When the first range is set, the judgment unit preferably performs a regression analysis or a principal component analysis on the sets of the fluorescence lifetime τ_{FRET} and the ratio R_{FRET} to determine a regression line or regression curve showing that the ratio R_{FRET} increases as the fluorescence lifetime τ_{FRET} decreases, and preferably sets the first range based on the regression line or the regression curve, and

when the second range is set, the judgment unit preferably determines an average of the fluorescence lifetime τ_{NON-FRET} of the sets and an average of the ratio R_{NON-FRET} of the sets, and preferably sets the second range based on the averages.

The sets of the fluorescence lifetime τₛₐₘₚₗₑ and the ratio Rₛₐₘₚₗₑ used by the judgment unit for the property judgment are preferably information selected prior to the judgment based on the fluorescence intensity of donor fluorescence and the fluorescence intensity of acceptor fluorescence.

### Advantageous Effects of Invention

The above-described FRET measurement device and FRET measurement method can accurately judge the presence or absence of the occurrence of FRET. This makes it possible to accurately understand the property of a test object such as a drug.

### BRIEF DESCRIPTION OF DRAWINGS

FIGS. 1A to 1C are diagrams that illustrate various states of a measuring probe.

FIG. 2 is a diagram that illustrates examples of energy absorption spectra and fluorescence emission spectra of a donor fluorescent substance and an acceptor fluorescent substance of the measuring probe illustrated in FIG. 1.

FIG. 3 is a schematic configuration diagram of a flow cytometer that is one embodiment of a FRET measurement device according to the present invention.

FIG. 4 is a schematic configuration diagram that illustrates one example of a light-receiving unit of this embodiment.

FIG. 5 is a schematic configuration diagram that illustrates one example of a control and processing unit of this embodiment.

FIG. 6 is a schematic configuration diagram that illustrates one example of an analyzing unit of this embodiment.

FIG. 7A is a diagram that illustrates examples of a region Z_{FRET} and a region Z_{NON-FRET} set on a scatter diagram used in this embodiment, and FIGS. 7B and 7C are diagrams that illustrate a method for setting the region Z_{FRET} and the region Z_{NON-FRET}.

FIGS. 8A and 8B are diagrams that illustrate a method for acquiring data used to judge the presence or absence of the occurrence of FRET in this embodiment.

FIG. 9A is a diagram that illustrates an example of a measurement result obtained by a FRET measurement method according to this embodiment.

FIG. 9B is a diagram that illustrates an example of a measurement result obtained by the FRET measurement method according to this embodiment.

FIG. 9C is a diagram that illustrates an example of a measurement result obtained by the FRET measurement method according to this embodiment.

FIG. 10 is a diagram that illustrates one example of the flow of the FRET measurement method according to this embodiment.

### DESCRIPTION OF EMBODIMENTS

Hereinbelow, a FRET measurement device and a FRET measurement method according to the present invention will be described in detail.

<Measuring Probe>

A measuring probe used in this embodiment is a probe for use in a flow cytometer 10 that will be described later as one embodiment of the FRET measurement device. More specifically, the probe is a FRET probe including a probe element X labeled with a donor fluorescent substance and a probe element Y labeled with an acceptor fluorescent substance. FRET occurs when the probe element X and the probe element Y approach to each other (or bind together) so that the donor fluorescent substance and the acceptor fluorescent substance are located close to each other (e.g., when the donor fluorescent substance and the acceptor fluorescent substance are located within a range of several nanometers). The flow cytometer 10 according to this embodiment uses a test sample containing this FRET probe as well as a test object (e.g., a drug) to judge the presence or absence of the occurrence of FRET. The test sample is, for example, biological cells incorporating the measuring probe and the test object. The test sample may be a suspension liquid directly containing the measuring probe and the test object therein without incorporating them into biological cells.

The use of this measuring probe makes it possible to determine whether or not the test object has the property of allowing the probe element X and the probe element Y to approach to each other (or bind together) (hereinafter, referred to as “approaching/binding property”) or the property of separating from each other the probe element X and the probe element Y that are in a state where they adjoin each other (or bind together) (hereinafter, referred to as “separating property”). For example, it is possible to determine whether a drug has the property of inducing the approach (or binding) of the probe element X and the probe element Y to each other or the property of inhibiting the approach (binding) of the probe element X and the probe element Y to each other. Further, it is possible to determine, inside a biological cell, whether action between the test probe and the test object incorporated into the biological cell, e.g., cell nucleus, is strong or weak. Further, it is possible to investigate a change in action between the test probe and the test object caused by a change in the environment of a biological cell or by production of a certain substance in a biological cell, e.g., cell nucleus.

It is to be noted that, in this embodiment, the probe element X and the probe element Y that form one probe body may be two separate elements, or part of one probe body may be formed from the probe element X and the probe element Y. When part of one probe body is formed from the probe element X and the probe element Y and the one probe body is deformed into a folded shape by increasing its bending angle, the probe element X and the probe element Y approach to each other (or bind together). When the one probe body being in a folded state is deformed so that its bending angle reduces, the probe element X and the probe element Y are separated from each other.

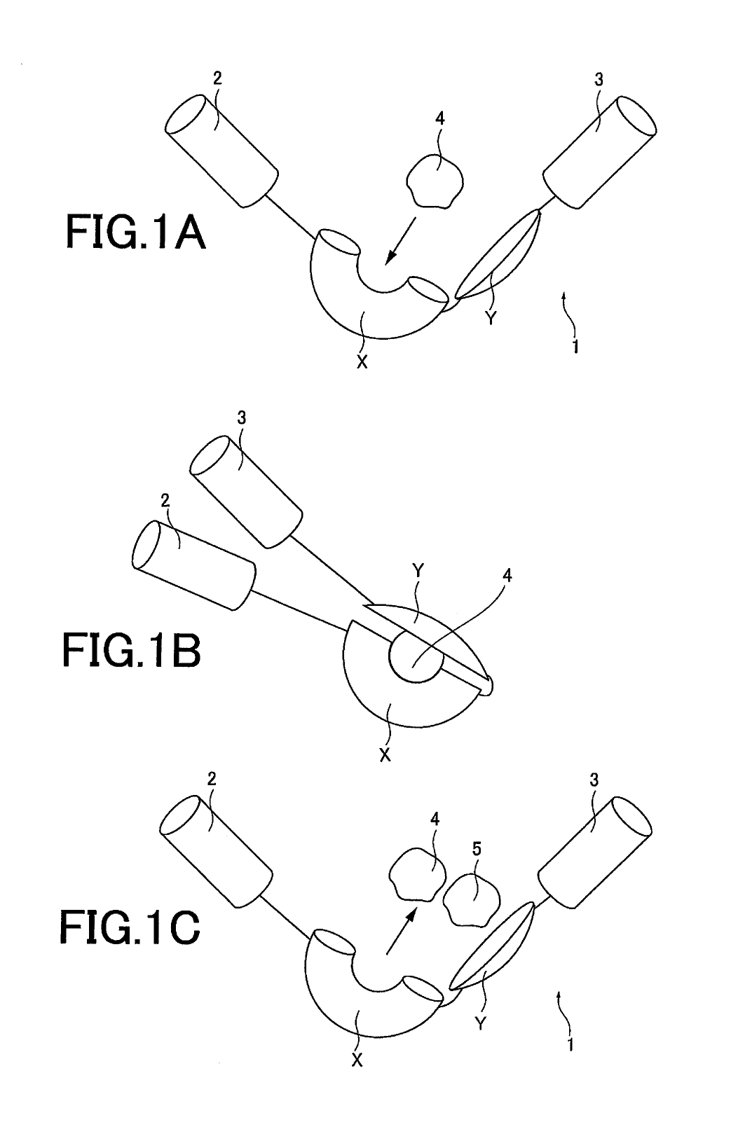

FIGS. 1A to 1C are diagrams that illustrate various states of a measuring probe 1. The measuring probe 1 includes a probe element X containing a donor fluorescent substance 2 and a probe element Y containing an acceptor fluorescent substance 3.

FIG. 1A illustrates a state where the probe element X labeled with the donor fluorescent substance 2 and the probe element Y labeled with the acceptor fluorescent substance 3 are separated from each other. When a test object 4 is given in this state, as illustrated in FIG. 1B, the probe element X and the probe element Y approach to each other (or bind together) so that the donor fluorescent substance 2 and the acceptor fluorescent substance 3 are located close to each other to the extent that FRET occurs. Further, when another test object 5 is given in the state illustrated in FIG. 1B, the labeled probe element X and the probe element Y labeled with the acceptor fluorescent substance 3 are separated from each other to the extent that FRET does not occur between the donor fluorescent substance 2 and the acceptor fluorescent substance 3. The FRET measurement device according to this embodiment uses, as a measuring object, a test object, such as the test object 4 or 5, about which it is unknown whether it has the property of allowing the probe element X and the probe element Y to approach to each other (or bind together) or the property of separating from each other the probe element X and the probe element Y that are in a state where they adjoin each other (or bind together). FRET is, of course, caused by irradiation of the donor fluorescent substance 2 with laser light.

In FIGS. 1A to 1C, the probe element X and the probe element Y are linked to and labeled with the donor fluorescent substance 2 and the acceptor fluorescent substance 3, respectively, by linking, but a linking method is not particularly limited and may be any method.

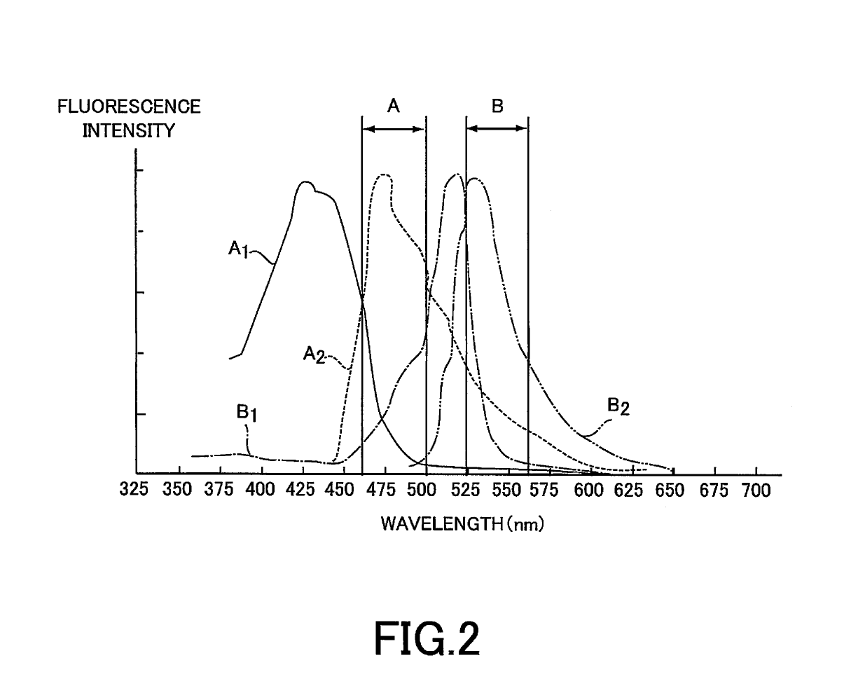

FIG. 2 is a diagram that illustrates examples of energy absorption spectra and fluorescence emission spectra of the donor fluorescent substance 2 and the acceptor fluorescent substance 3. As the donor fluorescent substance 2, for example, CFP (Cyan Fluorescent Protein) may be used. As the acceptor fluorescent substance 3, for example, YFP (Yellow Fluorescent Protein) may be used.

A curve A₁ represents the energy absorption spectrum of the donor fluorescent substance 2, and a curve A₂ represents the fluorescence emission spectrum of the donor fluorescent substance 2. A curve B₁ represents the energy absorption spectrum of the acceptor fluorescent substance 3, and a curve B₂ represents the fluorescence emission spectrum of the acceptor fluorescent substance 3.

As illustrated in FIG. 2, a wavelength range in which the donor fluorescent substance 2 mainly absorbs energy is 405 nm to 450 nm, and a wavelength range in which the acceptor fluorescent substance 3 mainly absorbs energy is 470 nm to 530 nm.

In general, when the distance between the donor fluorescent substance 2 and the acceptor fluorescent substance 3 is 2 nm or less, part of energy absorbed by the donor fluorescent substance 2 irradiated with laser light is transferred to the acceptor fluorescent substance 3 by coulomb interaction. The acceptor fluorescent substance 3 is excited by absorption of the energy transferred from the donor fluorescent substance 2 by coulomb interaction and emits fluorescence. This phenomenon is fluorescence resonance energy transfer (FRET). In this case, from the viewpoint of occurrence of strong FRET, an overlap in wavelength range between the curve A₂ representing the fluorescence emission spectrum of the donor fluorescent substance 2 and the curve B₁ representing the energy absorption spectrum of the acceptor fluorescent substance 3 is preferably wide.

When using such a measuring probe 1, the flow cytometer 10 that will be described later receives fluorescence emitted from the measuring probe 1 by irradiation with laser light. When receiving the fluorescence, the flow cytometer 10 calculates a fluorescence lifetime τₛₐₘₚₗₑ of donor fluorescence emitted from the donor fluorescent substance 2 (hereinafter, referred to as “donor fluorescence lifetime”) and a ratiometry Rₛₐₘₚₗₑ. The ratiometry Rₛₐₘₚₗₑ refers to a ratio of the fluorescence intensity of acceptor fluorescence emitted from the acceptor fluorescent substance 3 (hereinafter, referred to as “acceptor fluorescence intensity”) to the fluorescence intensity of donor fluorescence emitted from the donor fluorescent substance (hereinafter, referred to as “donor fluorescence intensity”). The flow cytometer 10 calculates a plurality of sets of the donor fluorescence lifetime τₛₐₘₚₗₑ and the ratiometry Rₛₐₘₚₗₑ. The flow cytometer 10 can accurately judge the presence or absence of the occurrence of FRET by using the sets of the fluorescence lifetime τₛₐₘₚₗₑ and the ratiometry Rₛₐₘₚₗₑ. Therefore, the flow cytometer 10 can accurately judge whether or not the test object has the approaching/binding property or the separating property. It is to be noted that, in the following description, fluorescence emitted from the donor fluorescent substance 2 is referred to as donor fluorescence, and fluorescence emitted from the acceptor fluorescent substance 3 is referred to as acceptor fluorescence.

<FRET Measurement Device>

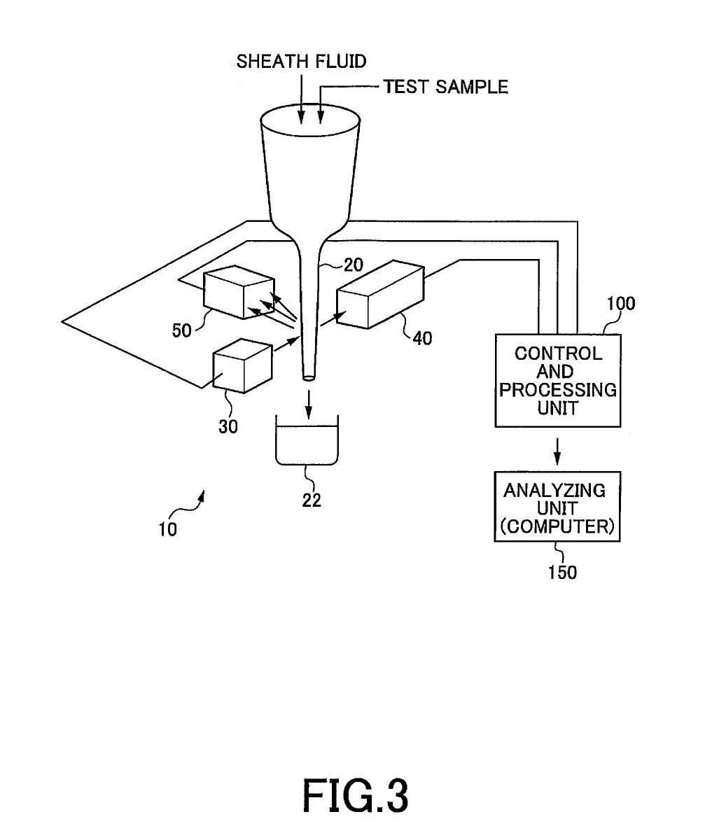

FIG. 3 is a schematic configuration diagram of the flow cytometer 10 that is one embodiment of the FRET measurement device according to the present invention.

The flow cytometer 10 according to this embodiment irradiates a sample containing, for example, the measuring probe 1 and the test object 5 with laser light, and measures fluorescence emitted from the sample. The flow cytometer 10 uses a measured fluorescent signal to judge FRET. As illustrated in FIG. 3, the flow cytometer 10 includes a conduit 20, a light source unit 30, light-receiving units 40 and 50, a control and processing unit 100, and an analyzing unit 150.

The conduit 20 allows a sheath fluid forming a high-speed flow and a test fluid containing a sample suspended therein to flow through it at the same time. In the conduit 20, a laminar sheath flow is formed in which the sample containing the measuring probe 1 flows in line. In the middle of the conduit 20, there is a laser light irradiation point as a measuring point. At this measuring point, the sample containing the measuring probe 1 sequentially emits fluorescence by irradiation with laser light. At the exit of the conduit 20, a collection container 22 is provided to collect the sample.

The following description will be made with reference to a case where the flow cytometer 10 judges whether FRET occurs or not, in order to judge whether or not the measuring probe 1 contained in the sample has changed to a state where, as illustrated in FIG. 1C, the probe element X and the probe element Y are separated from each other so that FRET does not occur between the donor fluorescent substance 2 and the acceptor fluorescent substance 3 when the test object 5 has been given in a state where, as illustrated in FIG. 1B, the probe element X and the probe element Y adjoin each other (or bind together) so that the donor fluorescent substance 2 and the acceptor fluorescent substance 3 are located close to each other (i.e., in a state where FRET occurs).

The light source unit 30 irradiates the measuring probe 1 passing through the measuring point in the conduit 20 with laser light whose intensity is modulated using a modulation signal. When the measuring probe 1 is irradiated with the laser light, the donor fluorescent substance 2 mainly absorbs energy. For example, when the donor fluorescent substance 2 is CFP (Cyan Fluorescent Protein) and the acceptor fluorescent substance 3 is YFP (Yellow Fluorescent Protein), laser light having a wavelength of 405 nm to 450 nm is used at which the donor fluorescent substance 2 mainly absorbs energy. The light source unit 30 is, for example, a semiconductor laser. The laser light emitted from the light source unit 30 has an output power of, for example, 5 mW to 100 mW. The measuring probe 1 irradiated with the laser light emitted from the light source unit 30 emits fluorescence, and the fluorescence is received by the light-receiving unit 50.

The light-receiving unit 40 is arranged so as to face the light source unit 30 across the conduit 20. The light-receiving unit 40 includes a photoelectric converter that outputs a detection signal indicating the passage of the measuring probe 1 through the measuring point when the measuring probe 1 passing through the measuring point scatters the laser light. The scattered-light signal outputted by the light-receiving unit 40 is supplied to the control and processing unit 100. The scattered-light signal supplied from the light-receiving unit 40 to the control and processing unit 100 is amplified in a signal processing unit 120 that will be described later, and is then processed by a phase difference detector 126 and a low-pass filter 128. Further, the scattered-light signal of forward-scattered light outputted by the light-receiving unit 40 is used as a trigger signal that announces the timing at which the measuring probe 1 passes through the measuring point in the conduit 20.

The light-receiving unit 50 is arranged on the line of intersection of a plane that passes through the measuring point and is orthogonal to the direction in which the laser light emitted from the light source unit 30 travels and a plane that passes through the measuring point and is orthogonal to the direction in which the measuring probe 1 in the conduit 20 moves. The light-receiving unit 50 includes photoelectric converters, such as photomultiplier tubes or avalanche photodiodes, that receive fluorescence emitted from the measuring probe 1 irradiated with the laser light at the measuring point and further receive side-scattered light generated by side scattering of the laser light caused by the measuring probe 1.

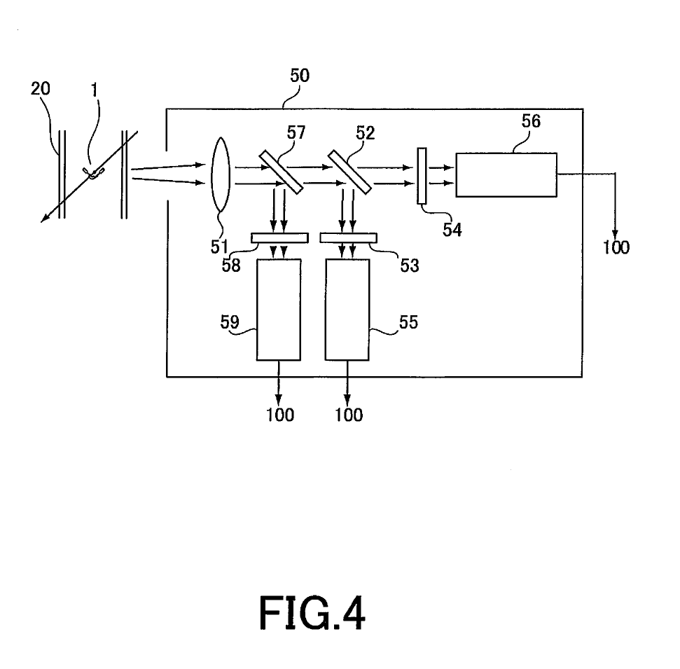

FIG. 4 is a schematic configuration diagram that illustrates one example of the light-receiving unit 50 of this embodiment. As illustrated in FIG. 4, the light-receiving unit 50 includes a lens system 51, dichroic mirrors 52 and 57, band-pass filters 53, 54, and 58, and photoelectric converters 55, 56, and 59.

The lens system 51 focuses fluorescence emitted from the measuring probe 1. The dichroic mirror 57 is configured to have such reflection and transmission wavelength characteristics that donor fluorescence and acceptor fluorescence are transmitted and side-scattered light of the laser light is reflected. The dichroic mirror 52 is configured to have such reflection and transmission wavelength characteristics that acceptor fluorescence is transmitted and donor fluorescence is reflected.

The band-pass filters 53, 54, and 58 are provided in front of the light-receiving surfaces of the photoelectric converters 55, 56, and 59. The band-pass filters 53, 54, and 58 transmit only light in a predetermined wavelength band. More specifically, the band-pass filter 53 is configured to transmit fluorescence in a wavelength band in which the donor fluorescent substance 2 mainly emits fluorescence (i.e., in a band denoted by A in FIG. 2). The band-pass filter 54 is configured to transmit fluorescence in a wavelength band in which the acceptor fluorescent substance 3 mainly emits fluorescence (i.e., in a band denoted by B in FIG. 2). The band-pass filter 58 is configured to have a transmission wavelength band that only light in the wavelength band of the laser light is transmitted.

The photoelectric converters 55, 56, and 59 convert received light to an electric signal. Each of the photoelectric converters 55 and 56 is, for example, a sensor equipped with a photomultiplier tube. The photoelectric converter 59 is, for example, a photodiode. Fluorescence received by the photoelectric converters 55 and 56 has a phase delay with respect to the intensity-modulated laser light. Therefore, each of the photoelectric converters 55 and 56 receives an optical signal having information about a phase difference with respect to the intensity-modulated laser light, and converts the optical signal to an electric signal. The signals (fluorescent signals, scattered-light signal) outputted by the photoelectric converters 55, 56, and 59 are supplied to the control and processing unit 100.

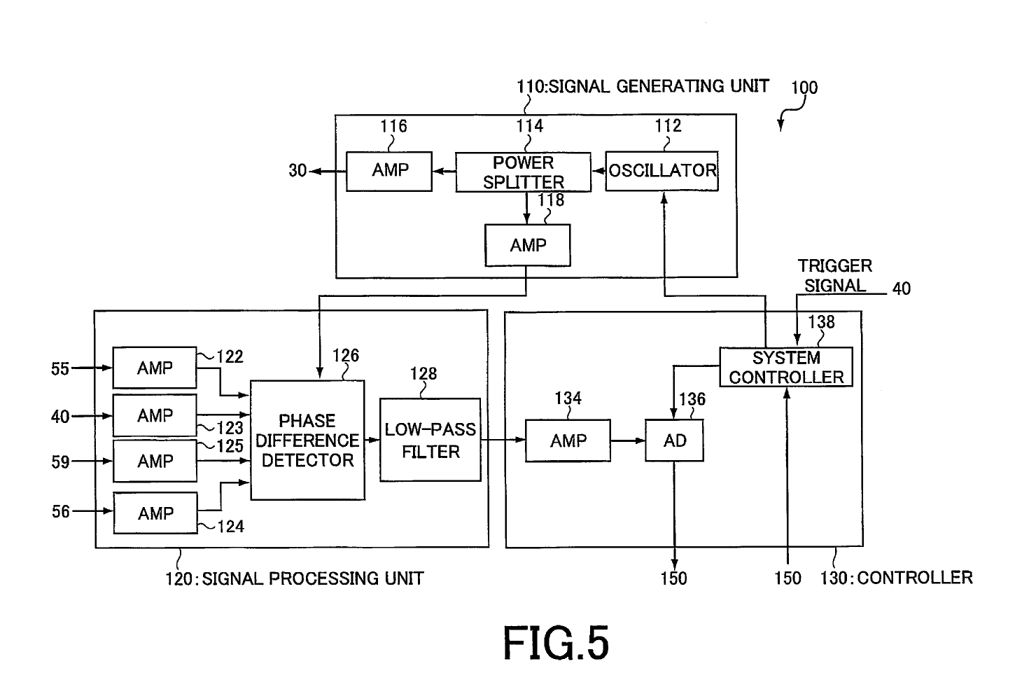

FIG. 5 is a schematic configuration diagram that illustrates one example of the control and processing unit 100 of this embodiment. As illustrated in FIG. 5, the control and processing unit 100 includes a signal generating unit 110, a signal processing unit 120, and a controller 130.

The signal generating unit 110 generates a modulation signal for time-modulating the intensity of the laser light. The modulation signal is, for example, a sinusoidal signal having a predetermined frequency, and the predetermined frequency is set to fall in the range of 10 MHz to 400 MHz.

The signal generating unit 110 includes an oscillator 112, a power splitter 114, and amplifiers 116 and 118. The modulation signal generated by the oscillator 112 is split by the power splitter 114, amplified, and then supplied to the light source unit 30 and the signal processing unit 120. The reason why the signal generating unit 110 supplies the modulation signal to the signal processing unit 120 is that, as will be described later, the modulation signal is used as a reference signal for determining the phase difference of fluorescence (donor fluorescence) emitted from the donor fluorescent substance 2 with respect to the modulation signal, more specifically the phase difference of the fluorescent signal with respect to the modulation signal. Further, the modulation signal is used as a signal for modulating the amplitude of the laser light emitted from the light source unit 30.

The signal processing unit 120 uses the fluorescent signal and the modulation signal to determine information about the phase difference of donor fluorescence emitted from the measuring probe 1 with respect to the modulation signal. Further, the signal processing unit 120 uses the scattered-light signal of forward-scattered light sent from the light-receiving unit 40 and the scattered-light signal of side-scattered light sent from the photoelectric converter 59 to determine information about the intensity of forward-scattered light and the intensity of side-scattered light.

The signal processing unit 120 includes amplifiers 122, 123, 124, and 125, the phase difference detector 126, and the low-pass filter 128.

The amplifiers 122, 123, 124, and 125 amplify the fluorescent signals and the scattered-light signals outputted by the photoelectric converters 55, 56, and 59 and the light-receiving unit 40, and output the amplified fluorescent signals and scattered-light signals to the phase difference detector 126.

The phase difference detector 126 detects the phase difference with respect to the modulation signal (reference signal) for each of the fluorescent signals of donor fluorescence and acceptor fluorescence, the scattered-light signals of forward-scattered light and side-scattered light, these signals being outputted by the photoelectric converters 55, 56, 59 and the light-receiving unit 40. The phase difference detector 126 has an IQ mixer not illustrated. The IQ mixer multiplies the reference signal and each signal to calculate a processed signal containing a cos component (real part) of the fluorescent signal and a high-frequency component. Further, the IQ mixer multiplies a signal obtained by shifting the phase of the reference signal by 90 degrees and each signal to calculate a processed signal containing a sin component (imaginary part) of the fluorescent signal and a high-frequency component. It is to be noted that the scattered-light signals of forward-scattered light and side-scattered light are signals generated by scattering of the laser light, and therefore their phase difference with respect to the modulation signal (reference signal) is 0.

The low-pass filter 128 removes the high-frequency component from the signals containing the cos and sin components of the fluorescent signal and the high-frequency component and outputted by the phase difference detector 126 to extract the cos and sin components of the fluorescent signal. Thus the signal processing unit 120 can obtain information about the phase difference of donor fluorescence with reference to the modulation signal (first phase difference). Further, the low-pass filter 128 removes a high-frequency component from signals containing cos and sin components of the scattered-light signals of forward-scattered light and side-scattered light and a high-frequency component and outputted by the phase difference detector 126 to extract the cos and sin components of the scattered-light signals.

The controller 130 controls the signal generating unit 110 so that the signal generating unit 110 generates, as a modulation signal, a sinusoidal signal having a set modulation frequency. The controller 130 performs AD conversion on the cos and sin components of the fluorescent signals and the scattered-light signals outputted by the signal processing unit 120.

The controller 130 includes an amplifier 134, an A/D converter 136, and a system controller 138. The amplifier 134 amplifies the processed signals containing the cos and sin components of the fluorescent signals and the scattered-light signals sent from the processing unit 120, and outputs the amplified processed signals to the A/D converter 136. The A/D converter 136 samples the processed signals containing the cos and sin components of the fluorescent signals and the scattered-light signals, and supplies them to the analyzing device 150. The system controller 138 receives an input of the trigger signal outputted by the light-receiving unit 40. The system controller 138 controls the oscillator 112 and the A/D converter 136.

The analyzing unit 150 calculates fluorescence lifetime, fluorescence intensity, forward-scattered light intensity, side-scattered light intensity, etc. from the processed signals containing the cos and sin components (real and imaginary parts) of the fluorescent signal of donor fluorescence, the fluorescent signal of acceptor fluorescence, the scattered-light signal of forward-scattered light, and the scattered-light signal of side-scattered light.

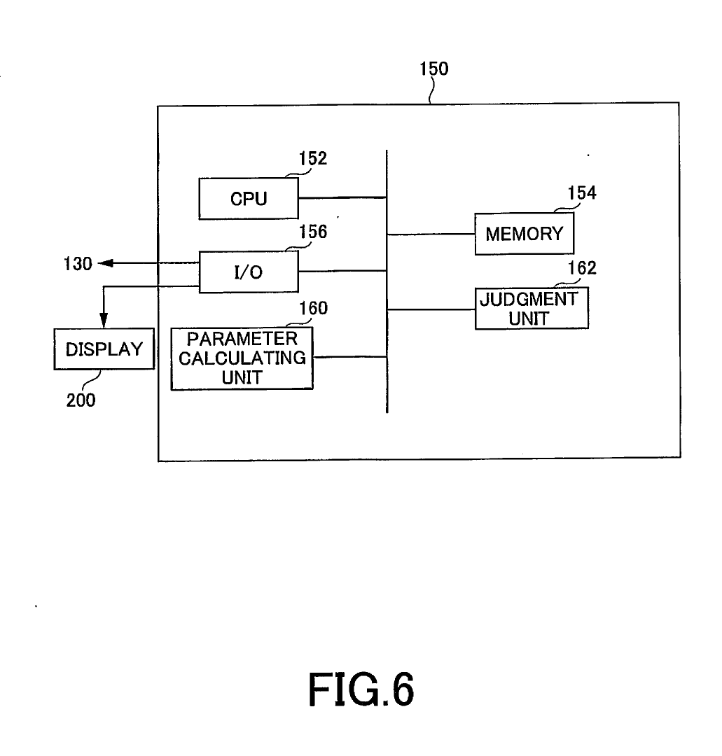

The analyzing unit 150 is a device configured by executing a predetermined program on a computer. FIG. 6 is a schematic configuration diagram that illustrates one example of the analyzing unit 150 of this embodiment. As illustrated in FIG. 6, the analyzing unit 150 includes a CPU 152, a memory 154, and an input-output port 156, and further includes a parameter calculating unit 160 and a judgment unit 162 that are configured by executing the program.

The analyzing unit 150 is connected to a display 200 via the input-output port 156. The analyzing unit 150 is connected also to the controller 130 via the input-output port 156.

The CPU 152 is an arithmetic processor provided in the computer. The CPU 152 virtually performs various calculations of the parameter calculating unit 160 and the judgment unit 162.

The memory 154 includes ROM that stores the program executed on the computer to configure the parameter calculating unit 160 and the judgment unit 162 as modules and RAM that memorizes processing results calculated by these parts and data supplied from the input-output port 156.

The input-output port 156 receives an input of values of the cos and sin components (real and imaginary parts) of the fluorescent signals and the scattered-light signals supplied from the controller 130. The input-output port 156 outputs processing results calculated by the various units to the display 200.

The display 200 displays a variety of information or processing results determined by the various units.

The parameter calculating unit 160 uses the input of values of the cos and sin components (real and imaginary parts) of the fluorescent signal of donor fluorescence supplied from the controller 130 to calculate the fluorescence lifetime of the donor fluorescent substance 2. For example, the parameter calculating unit 160 determines the phase difference of the fluorescent signal with respect to the modulation signal (first phase difference) from the values of cos and sin components of the fluorescent signal supplied from the controller 130. Further, the parameter calculating unit 160 uses the determined phase difference to calculate the fluorescence lifetime of the donor fluorescent substance 2. More specifically, the parameter calculating unit 160 divides, based on τₛₐₘₚₗₑ=tan θ/(2πf), the tan component of the phase difference θ by the angular frequency 2πf (f is a modulation frequency) of the modulation signal to calculate the fluorescence lifetime τₛₐₘₚₗₑ of donor fluorescence of the measuring probe 1. The fluorescence lifetime is expressed as a fluorescence relaxation time constant defined by assuming that the fluorescence components emitted by laser light irradiation are based on a relaxation response of first-order lag system.

Further, the parameter calculating unit 160 uses the input of values of the cos and sin components (real and imaginary parts) of the fluorescent signal of donor fluorescence, the fluorescent signal of acceptor fluorescence, the scattered-light signal of forward-scattered light, and the scattered-light signal of side-scattered light supplied from the controller 130 to calculate the fluorescence intensity of donor fluorescence, the fluorescence intensity of acceptor fluorescence, the intensity of forward-scattered light, and the intensity of side-scattered light. More specifically, the parameter calculating unit 160 calculates the square root of the sum of squares of values of the cos component (real part) and sin component (imaginary part) for each of the fluorescent signal of donor fluorescence, the fluorescent signal of acceptor fluorescence, the scattered-light signal of forward-scattered light, and the scattered-light signal of side-scattered light to obtain fluorescence intensity, forward-scattered light intensity, and side-scattered light intensity.

The judgment unit 162 judges whether or not the test object 5 has the separating property by using a plurality of sets of the fluorescence lifetime τₛₐₘₚₗₑ and the ratio (hereinafter, referred to as “ratiometry”) Rₛₐₘₚₗₑ which are obtained from measurements every time the measuring probe 1 passes through the measuring point. The number of the sets of the fluorescence lifetime τₛₐₘₚₗₑ and the ratiometry Rₛₐₘₚₗₑ is defined as N. More specifically, the judgment unit 162 previously sets a first range in which the fluorescence lifetime τₛₐₘₚₗₑ and the ratiometry Rₛₐₘₚₗₑ can take values when FRET occurs and a second range in which the fluorescence lifetime τₛₐₘₚₗₑ and the ratiometry Rₛₐₘₚₗₑ can take values when FRET does not occur. The judgment unit 162 extracts a first set group contained in the first range from all the measured sets of the fluorescence lifetime τₛₐₘₚₗₑ and the fluorescence intensity ratiometry Rₛₐₘₚₗₑ to determine a first ratio N₁/N which is a ratio of the number N₁ of the sets of the extracted first set group to the number N of all the sets. Similarly, the judgment unit 162 extracts a second set group contained in the second range to determine a second ratio N₂/N which is a ratio of the number N₂ of the sets of the extracted second set group to the number N of all the sets. The judgment unit 162 judges the presence or absence of the occurrence of FRET by using the determined first ratio N₁/N and second ratio N₂/N. Thus, the judgment can be made whether or not the test object 5 has the separating property.

The judgment unit 162 can set the first range and the second range by, for example, the following method, but the first range and the second range may be set by another method.

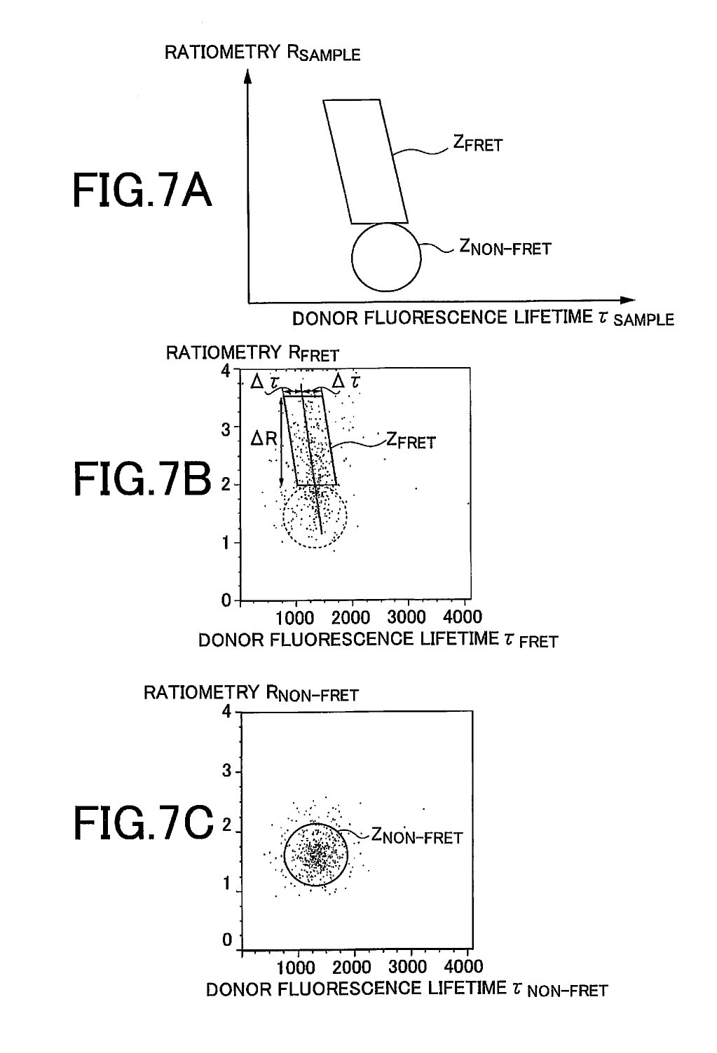

More specifically, the judgment unit 162 sets a region defined by the first range as a region Z_{FRET} and sets a region defined by the second range as a region Z_{NON-FRET} on a scatter diagram whose horizontal axis represents the fluorescence lifetime τₛₐₘₚₗₑ and vertical axis represents the ratiometry Rₛₐₘₚₗₑ. FIG. 7A is a diagram that illustrates examples of the region Z_{FRET} and the region Z_{NON-FRET}.

In this case, the first range, that is, the region Z_{FRET} can be set by determining a plurality of sets of a fluorescence lifetime τ_{FRET} of donor fluorescence and a ratiometry R_{FRET}, which is a ratio of the fluorescence intensity of acceptor fluorescence to the fluorescence intensity of donor fluorescence, measured by the flow cytometer 10 using a positive control sample containing the measuring probe 1 whose probe element X and probe element Y approach to each other or bind together.

Similarly, the second range, that is, the region Z_{NON-FRET} can also be set by determining a plurality of sets of a fluorescence lifetime τ_{NON-FRET} of donor fluorescence and a ratiometry R_{NON-FRET}, which is a ratio of the fluorescence intensity of acceptor fluorescence to the fluorescence intensity of donor fluorescence, measured by the flow cytometer 10 using a negative control sample containing the measuring probe 1 whose probe element X and probe element Y do not approach to each other or bind together.

The judgment unit 162 preferably sets the region Z_{FRET} in the following manner: a regression analysis or a principal component analysis is performed on the data of the sets of the fluorescence lifetime τ_{FRET} and the ratiometry R_{FRET} obtained using the positive control sample to determine a regression line or a regression curve showing that the ratiometry R_{FRET} increases as the fluorescence lifetime τ_{FRET} decreases, and then a range in which the fluorescence lifetime τ_{FRET} and the ratiometry R_{FRET} can take values is set as the region Z_{FRET} based on the regression line or the regression curve. For example, when the standard deviation of the fluorescence lifetime τ_{FRET} is defined as σ_{τ}, the judgment unit 162 adds, around the regression line or the regression curve, a range in which the fluorescence lifetime τ_{FRET} can take values, the range being represented by ±Δτ determined by, for example, a range represented by ±a·τ_{τ} (a is a given number of, for example, 1 or more but 3 or less). Further, when the standard deviation of the ratiometry R_{FRET} is defined as τ_{R}, the judgment unit 162 adds, to the average of the ratiometry R_{FRET}, ±ΔR determined by b·σ_{R} (b is a given number of, for example, 1 or more but 3 or less) to set a range in which the ratiometry R_{FRET} can take values.

Further, the judgment unit 162 preferably sets the region Z_{NON-FRET} in the following manner: the average of the sets of the fluorescence lifetime τ_{NON-FRET} and the ratiometry R_{NON-FRET} is determined, and a range, in which the fluorescence lifetime τ_{NON-}FRET and the ratiometry R_{NON-FRET} can take values, is set as the region Z_{NON-FRET} based on the average. For example, when the standard deviation of the fluorescence lifetime τ_{FRET} is defined as σ_{τ} and the standard deviation of the ratiometry R_{FRET} is defined as σ_{R}, the judgment unit 162 can set, as the region Z_{NON-FRET}, a region within a circle whose radius is a smaller or larger one of, for example, c·σ_{τ} (c is a given number of 1 or more but 3 or less) and d·σ_{R} (d is a given number of, for example, 1 or more but 3 or less) or an ellipse whose radii are both of them. Alternatively, the judgment unit 162 may set, as the region Z_{NON-FRET}, a region within a circle whose center is the above-described average and which contains 40% to 100% of data plotted on the scatter diagram.

There is a case where the region of the data plotted on the scatter diagram obtained using the positive control sample (data of the positive control sample) and the region of the data plotted on the scatter diagram obtained using the negative control sample (data of the negative control sample) overlap one another, that is, the region Z_{NON-FRET} set using the negative control sample contains much data plotted on the scatter diagram obtained using the positive control sample. In this case, the region Z_{FRET} can be set using the remaining data of the positive control sample excluding the data contained in the region Z_{NON-FRET}. There is a case where the data of the positive control sample is likely to be contained in the region Z_{NON-FRET} or the data of the negative control sample is likely to be contained in the region Z_{FRET}. In the latter case, the region Z_{NON-FRET} can be set by previously setting the Z_{FRET} and then excluding the data of the negative control sample contained in the region Z_{FRET} from the data of the negative control sample.

FIG. 7B illustrates a result obtained by plotting the sets of the fluorescence lifetime τ_{FRET} and the ratiometry R_{FRET} obtained using the positive control sample, an example of the set region Z_{FRET}, and an example of the regression line. FIG. 7C illustrates a result obtained by plotting the sets of the fluorescence lifetime τ_{NON-FRET} and the ratiometry R_{NON-FRET} obtained using the negative control sample and an example of the region Z_{NON-FRET}.

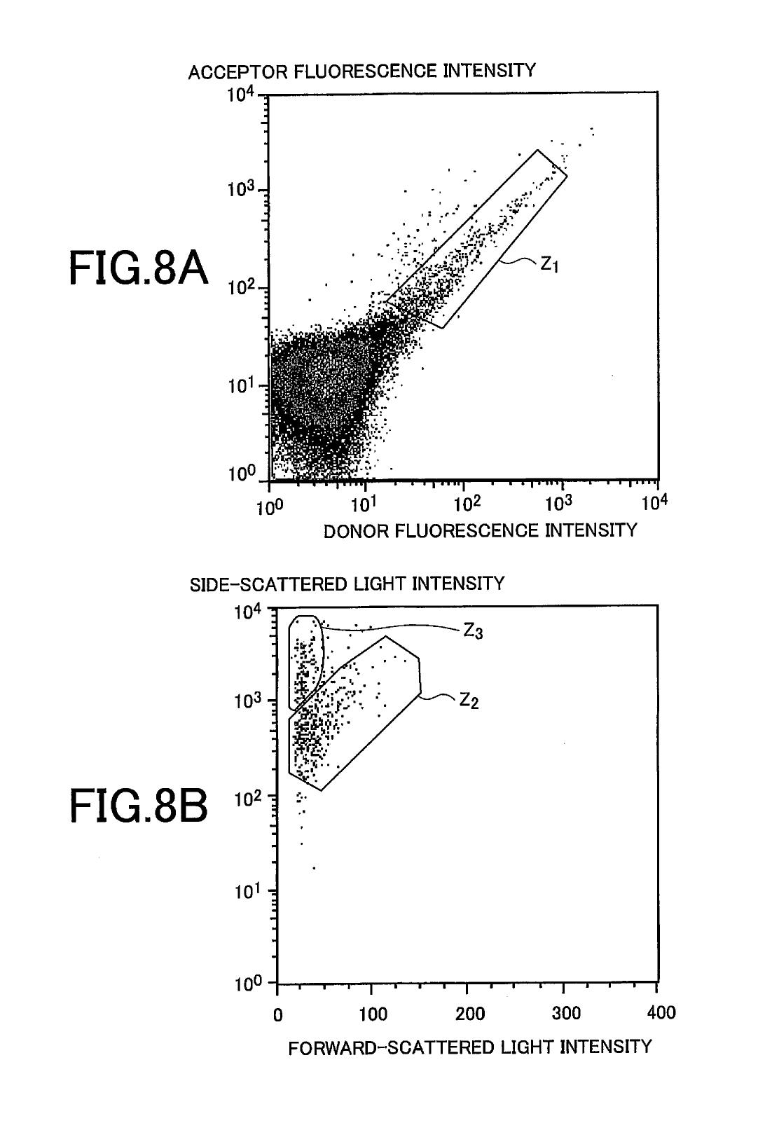

FIG. 8A illustrates a scatter diagram that has two axes representing donor fluorescence intensity and acceptor fluorescence intensity and that is obtained by plotting donor fluorescence intensity and acceptor fluorescence intensity measured by the flow cytometer 10 using a test sample. In the case of this scatter diagram, only data contained in a region Z₁ is preferably selected to judge the presence or absence of FRET. More specifically, a plurality of plotted points, that is, a plurality of sets of the fluorescence lifetime τₛₐₘₚₗₑ and the ratio Rₛₐₘₚₗₑ used for judgment of the property of the test object 5 are preferably information selected prior to judgment based on the fluorescence intensity of donor fluorescence and the fluorescence intensity of acceptor fluorescence. For example, a plurality of sets of the fluorescence lifetime τₛₐₘₚₗₑ and the ratio Rₛₐₘₚₗₑ determined when the values of donor fluorescence intensity and acceptor fluorescence intensity are equal to or more than both preset values are preferably used by the judgment unit 162 to judge FRET and then to judge the property of the test object 5. Such data is derived from the fact that the probe element X and the probe element Y are labeled with large amounts of the donor fluorescent substance 2 and the acceptor fluorescent substance 3, and therefore the presence or absence of FRET can be more accurately judged. More preferably, a plurality of sets of the fluorescence lifetime τₛₐₘₚₗₑ and the ratio Rₛₐₘₚₗₑ determined when the values of donor fluorescence intensity and acceptor fluorescence intensity are equal to or more than both preset values but are equal to or less than other preset values are used for the judgment of FRET and then for the judgment of the property of the test object 5.

It is to be noted that the judgment unit 162 may use a weighted number of plotted points as the number N₁ of plotted points located in the region Z_{FRET} on the scatter diagram whose horizontal axis and vertical axis represent the fluorescence lifetime τ_{FRET} and the ratiometry R_{FRET}, respectively. Then, the weighted number is determined by accumulating values of a weighting coefficient which increases as the reciprocal of the shortest distance (or the reciprocal of square of the shortest distance) from each plotted position of the fluorescence lifetime τₛₐₘₚₗₑ and the ratiometry Rₛₐₘₚₗₑ located in the region Z_{FRET} to the above-described regression line (see FIG. 7B) or regression curve increases. That is, as the number N₁ of plotted points located in the region Z_{FRET}, a sum of values of the weighting coefficient determined for each plotted point in the region Z_{FRET} on the scatter diagram may also be used. The sum is smaller as the amount of data located near the regression line or the regression curve is smaller. In this case, the judgment unit 162 acquires the above-described sum obtained through weighting as information about the number N₁ including the dispersion of data for the sets of the first set group located in the region Z_{FRET}. Therefore the judgment unit 162 can more accurately judge the presence or absence of the occurrence of FRET. Further, the weighted number of plotted points determined by accumulating values of a weighting coefficient may also be used as information about the number N₂ of the sets of the second set group located in the region Z_{NON-FRET}. The weighting coefficient increases as the reciprocal of the shortest distance (or the reciprocal of square of the shortest distance) from each plotted position of the fluorescence lifetime τₛₐₘₚₗₑ the ratio Rₛₐₘₚₗₑ located in the region Z_{NON-FRET} to the position of the average in the region Z_{NON-FRET} increases. That is, a sum of values of the weighting coefficient determined for each plotted point may also be used as information about the number N₂.

Further, when the measuring probe 1 is incorporated into biological cells and the biological cells incorporating the measuring probe 1 are irradiated with laser light, the judgment unit 162 may select only data contained in a preset region Z₂ on a scatter diagram, whose horizontal axis and vertical axis represent forward-scattered light intensity and side-scattered light intensity measured by the flow cytometer 10 using a test sample, and use the data indicating that the biological cells are living cells to judge the presence or absence of FRET. When the biological cells are dead cells, they have surface irregularities and their size is reduced so that their laser light-scattering characteristics are also changed. A region Z₃ illustrated in FIG. 8B is a region of dead cells. Such regions Z₂ and Z₃ can be previously acquired by previously measuring living cells and dead cells using the flow cytometer 10.

Further, when a regression line is obtained by performing a regression analysis or a principal component analysis on the plotted data contained in the region Z_{FRET} illustrated in FIG. 7B, the judgment unit 162 can also judge the reliability of the presence or absence of the occurrence of FRET by utilizing the ratio between dispersion in the axial direction of the axis of a regression line determined by a regression analysis or a principal component axis determined by a principal component analysis and dispersion in a direction orthogonal to the axial direction. For example, when two or more kinds of samples are measured, the judgment unit 162 can also judge that the reliability of the result is higher when the dispersion ratio is smaller (ellipticity is larger).

A quotient determined by dividing the intensity of donor fluorescence by the fluorescence lifetime of donor fluorescence is proportional to the amount of the donor fluorescent substance 2 labeling the probe element X. Therefore, the judgment unit 162 may form a histogram showing the distribution of the quotients obtained by measuring the measuring probes 1 and use only data contained in the range of the average of the quotients ±e·σ (σ is the standard deviation of the quotients and e is a given number of 1 or more but 2 or less) in this histogram to judge the presence or absence of FRET and then to judge whether or not the test object 5 has the separating property. The data contained in the range of the average of the quotients ±e·σ is almost the same in the amount of the donor fluorescent substance 2 labeling the probe element X, and therefore FRET is likely to occur with stability.

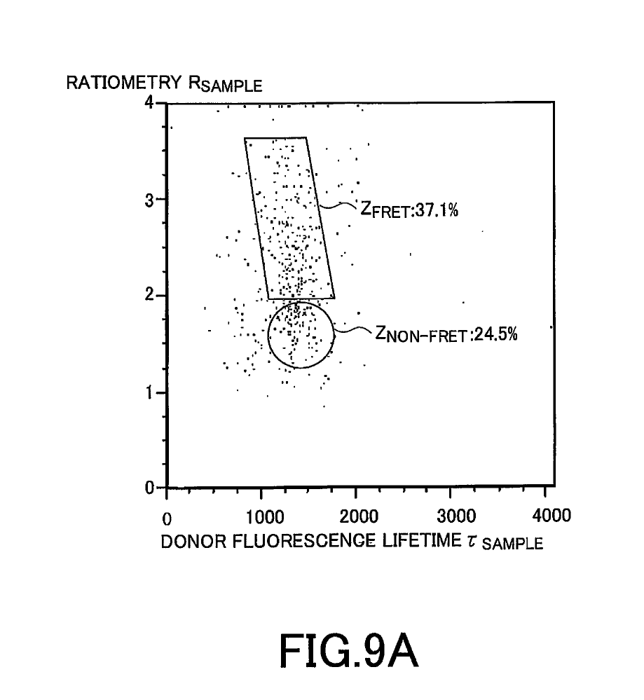

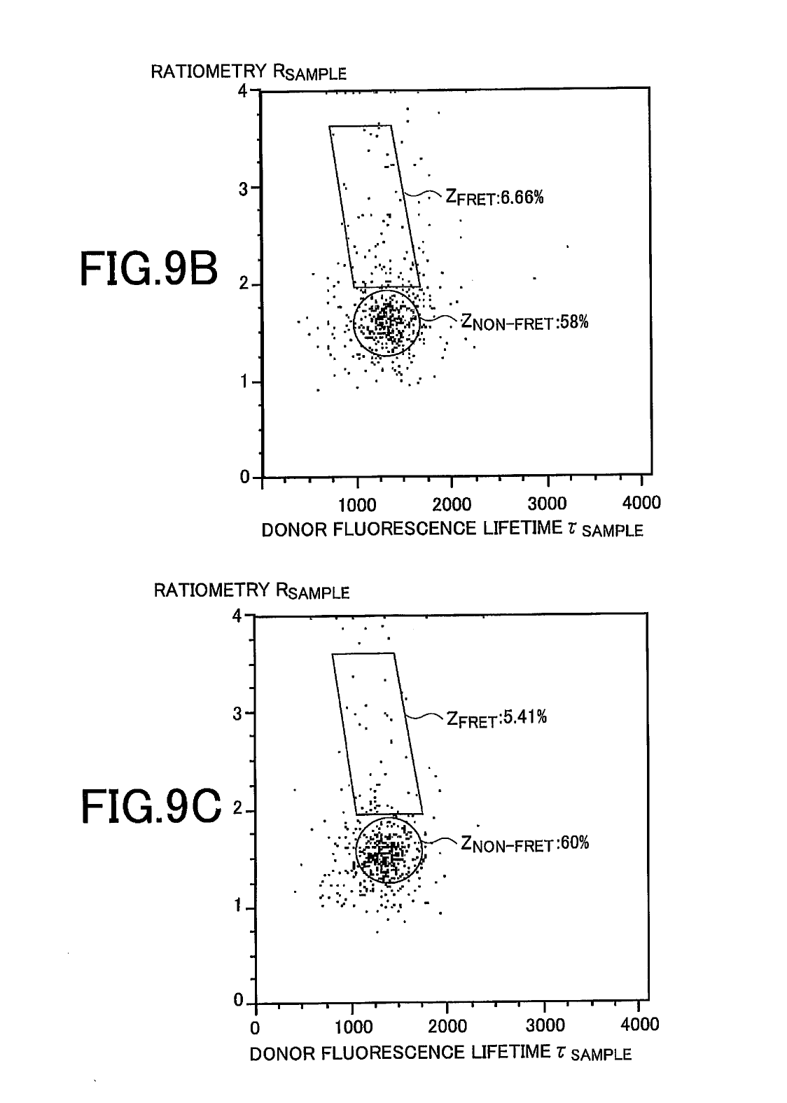

FIG. 9A is an example of a scatter diagram that illustrates the result of measuring a positive control sample with the use of the flow cytometer 10 by flowing the positive control sample through the conduit 20.

FIG. 9B is an example of a scatter diagram that illustrates the result of measuring a test sample obtained by adding the test object 5 to the measuring probe 1 with the use of the flow cytometer 10 by flowing the test sample through the conduit 20, and FIG. 9C is an example of a scatter diagram that illustrates the result of measuring a test sample obtained by adding the test object 5, which is different from that used in the example illustrated in FIG. 9B, to the measuring probe 1 with the use of the flow cytometer 10 by flowing the test sample through the conduit 20. It is to be noted that as illustrated in FIG. 9A, the amount of data located in the region Z_{FRET} and the amount of data located in the region Z_{NON-FRET} were 37.1% and 24.5% of all the data of the positive control sample, respectively.

On the other hand, in the case of the example illustrated in FIG. 9B, the first ratio N₁/N, that is, the amount of data (the number of plotted points) of the first set group located in the region Z_{FRET} is 6.66%, and the second ratio N₂/N, that is, the amount of data (the number of plotted points) of the second set group located in the region Z_{NON-FRET} is 58%.

In the case of the example illustrated in FIG. 9C, the first ratio N₁/N, that is, the amount of data (the number of plotted points) of the first set group located in the region Z_{FRET} is 5.41%, and the second ratio N₂/N, that is, the amount of data (the number of plotted points) of the second set group located in the region Z_{NON-FRET} is 60%. In both cases using these two test objects 5, FRET is less likely to occur, and therefore the two test objects 5 are judged to have the separating property. Further, the judgment unit 162 judges that the test object 5 used in the example illustrated in FIG. 9C is much less likely to enable occurrence of FRET than the test object 5 used in the example illustrated in FIG. 9B, that is, the test object 5 used in the example illustrated in FIG. 9C has a higher separating property than the test object 5 used in the example illustrated in FIG. 9B.

The judgment unit 162 may, of course, judge the presence or absence of the occurrence of FRET by comparing obtained values of the first ratio N₁/N and the second ratio N₂/N with preset threshold values of the first ratio N₁/N and the second ratio N₂/N, respectively, and then, based on this judgment, judge whether or not the test object 5 has the separating property.

As described above, the flow cytometer 10 according to this embodiment uses a plurality of sets of the fluorescence lifetime τₛₐₘₚₗₑ and the ratio Rₛₐₘₚₗₑ, and therefore can accurately judge the presence or absence of the occurrence of FRET and then accurately judge whether or not the test object 5, such as a drug, has the approaching/binding property or the separating property.

The judgment unit 162 previously sets the first range in which the fluorescence lifetime τₛₐₘₚₗₑ and the ratiometry Rₛₐₘₚₗₑ can take values when FRET occurs and the second range in which the fluorescence lifetime τₛₐₘₚₗₑ and the ratiometry Rₛₐₘₚₗₑ can take values when FRET does not occur, and judges the presence or absence of the occurrence of FRET using the first ratio N₁/N and the second ratio N₂/N. Therefore, the judgment unit 162 can more accurately judge whether or not the test object 5 has the property.

The judgment unit 162 determines a plurality of sets of the fluorescence lifetime τ_{FRET} of donor fluorescence and the ratiometry R_{FRET} measured by the flow cytometer 10 using the positive control sample to set the first range, that is, the region Z_{FRET} on the scatter diagram. Further, the judgment unit 162 determines a plurality of sets of the fluorescence lifetime τ_{NON-FRET} of donor fluorescence and the ratiometry R_{NON-FRET} measured by the flow cytometer 10 using the negative control sample to previously set the second range, that is, the region Z_{NON-FRET} on the scatter diagram. Therefore, measurement of the test sample and the judgment of the test object 5 can be accurately performed using the same flow cytometer 10.

Further, the judgment unit 162 performs a regression analysis or a principal component analysis on a plurality of sets of the fluorescence lifetime τ_{FRET} and the ratiometry R_{FRET} to determine a regression line or a regression curve showing that the ratiometry R_{FRET} increases as the fluorescence lifetime τ_{FRET} decreases, and then, based on this regression line or the regression curve, sets the first range, that is, the region Z_{FRET} on the scatter diagram. Further, the judgment unit 162 determines the average of a plurality of sets of the fluorescence lifetime τ_{NON-FRET} and the ratiometry R_{NON-FRET}, and then, based on this average, sets the second range, that is, the region Z_{NON-FRET} on the scatter diagram. Therefore, the first and second ranges can be quantitatively set independent of the arbitrariness of an operator of the flow cytometer 10.

<FRET Measurement Method>

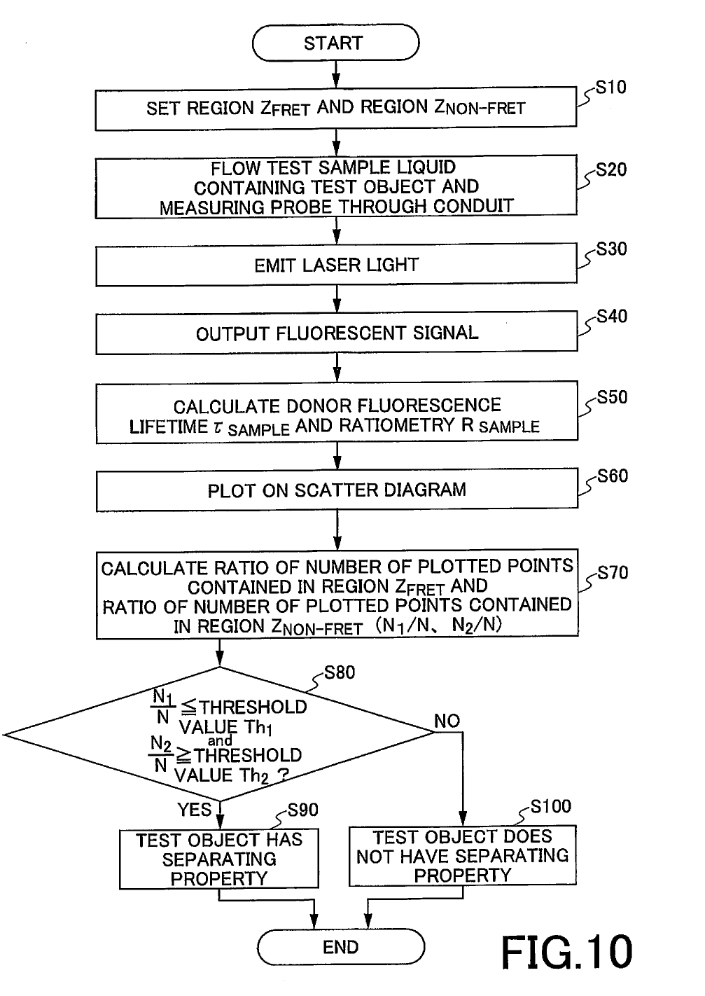

FIG. 10 is a diagram that illustrates the flow of one example of the FRET measurement method according to this embodiment. The flow illustrated in FIG. 10 will be described with reference to a case where, when the test object 5 is given to the measuring probe 1 being in a state illustrated in FIG. 1B, a judgment is made whether or not the test object 5 has the property of exhibiting such an effect as illustrated in FIG. 1C, that is, whether or not the test object 5 has the property of separating the probe element X and the probe element Y from each other.

First, as illustrated in FIG. 1B, the measuring probe 1 is prepared which is in a state where the probe element X and the probe element Y adjoin each other (or bind together) so that the donor fluorescent substance 2 and the acceptor fluorescent substance 3 are in a state where they are located close to each other and enable FRET to occur. A test sample containing this measuring probe 1 and the test object 5 is prepared.

In this state, since the probe element X and the probe element Y of the measuring probe 1 are known elements, the judgment unit 162 calls the region Z_{FRET} and the region Z_{NON-FRET} on the scatter diagram previously measured and set by the flow cytometer 10 and stored in the memory 154. And the judgment unit 162 sets the region Z_{FRET} and the region Z_{NON-FRET} on a scatter diagram (Step 10). The scatter diagram, the region Z_{FRET}, and the region Z_{NON-FRET} are displayed on the display 200.

The region Z_{FRET} and the region Z_{NON-FRET} are previously extracted by, for example, measuring a positive control sample and a negative control sample with the use of the flow cytometer 10. The region Z_{FRET} and the region Z_{NON-FRET} are set by, for example, the above-described statistical processing, including a principal component analysis or a regression analysis, based on a scatter diagram obtained by plotting a plurality of sets of measured fluorescence lifetime τ_{FRET} and ratiometry R_{FRET} and a plurality of sets of measured fluorescence lifetime τ_{NON-FRET} and ratiometry R_{NON-FRET}.

Then, the prepared test sample is flowed through the conduit 20 in the flow cytometer 10 (Step S20). At this time, the light source unit 30 emits laser light whose intensity is modulated using a modulation signal toward the conduit 20 (Step S30). Therefore, the measuring probe 1 passing through the measuring point in the conduit 20, on which the laser light is converged, is irradiated with the laser light and emits fluorescence. Further, the light-receiving unit 50 receives the fluorescence emitted from the measuring probe 1 and outputs fluorescent signals (Step S40).

The signal processing unit 120 processes the fluorescent signals outputted by the light-receiving unit 50 to generate cos and sin components of the fluorescent signals. That is, the signal processing unit 120 determines information about the phase difference of donor fluorescence emitted from the measuring probe 1 with respect to the modulation signal (first phase difference).

Further, the analyzing unit 150 uses the cos and sin components of the fluorescent signals to calculate a fluorescence lifetime τ_{SAMPLE} of donor fluorescence and a ratiometry R_{SAMPLE} that is a ratio of acceptor fluorescence intensity to donor fluorescence intensity (Step S50). In this embodiment, the fluorescence lifetime τ_{SAMPLE} and the ratiometry R_{SAMPLE} are calculated every time the measuring probe 1 in the sample is irradiated with the laser light when passing through the measuring point in the conduit 20, and therefore a very large amount of data of the fluorescence lifetime τ_{SAMPLE} and the ratiometry R_{SAMPLE} is obtained when all the test sample is examined. Therefore, the judgment unit 162 plots data about the fluorescence lifetime τ_{SAMPLE} and the ratiometry R_{SAMPLE} on the scatter diagram every time a large amount of the data is acquired (Step S60). In this way, such a scatter diagram as illustrated in FIG. 9B or 9C is formed.

The judgment unit 162 counts the amount of data contained in each of the preset region Z_{FRET} and region Z_{NON-FRET} to calculate a first ratio N₁/N and a second ratio N₂/N (Step S70).

The judgment unit 162 further uses the first ratio N₁/N and the second ratio N₂/N to judge the presence or absence of the occurrence of FRET (Step S80). More specifically, the judgment unit 162 judges whether or not the first ratio N₁/N is a preset threshold value Th₁ or less and the second ratio N₂/N is a preset threshold value Th₂ or more.

When the judgment result is YES, the judgment unit 162 judges that no FRET has occurred and then judges that the test object 5 has the separating property (Step S90). On the other hand, when the judgment result is NO, the judgment unit 162 judges that FRET has occurred and then judges that the test object 5 does not have the separating property (Step S100).

As described above, in this embodiment, the judgment unit 162 judges whether or not the first ratio N₁/N is a preset threshold value Th₁ or less and the second ratio N₂/N is a preset threshold value Thₑ or more. However, the judgment unit 162 may use, as a criterion for judgment, only one of whether or not the first ratio N₁/N is a preset threshold value Th₁ or less and whether or not the second ratio N₂/N is a preset threshold value Th₂ or more.

Alternatively, the judgment unit 162 may use, as a criterion for judgment, whether or not a reduction rate obtained by subtracting, from 1, a value determined by dividing a first ratio N₁/N, which is determined when the test sample containing the test object 5 and the measuring probe 1 is measured, by a first ratio N₁/N, which is determined when the measuring probe 1 of the positive control sample is measured (see the following formula) is a preset threshold value or less.

Reduction rate=1−(first ratio N₁/N of test sample)/(first ratio N₁/N of positive control sample)

The reduction rate of the example illustrated in FIG. 9B is 0.820 (=1−6.66%/37.1%), and the reduction rate of the example illustrated in FIG. 9C is 0.854 (=1−5.41%/37.1%). In this case, when the threshold value is set to, for example, 0.30, the judgment unit 162 can judge that both the test objects 5 used in the examples illustrated in FIGS. 9B and 9C have the separating property. Further, the reduction rate of the example illustrated in FIG. 9C is larger than the reduction rate of the example illustrated in FIG. 9B, and therefore the judgment unit 162 can judge that the test object 5 used in the example illustrated in FIG. 9C has a higher degree of separating property than the test object 5 used in the example illustrated in FIG. 9B.

Such judgment results are displayed on the display 200.

In this way, the flow cytometer 10 can judge, in a short time, whether or not the test object 5 has the property of separating from each other the probe element X and the probe element Y of the measuring probe 1.

The FRET measurement method according to this embodiment can be suitably used for development of a test for the sensitivity of a molecularly-targeted drug for leukemia. Chronic myelocytic leukemia (CML) is a chronic myelo-proliferative disorder that occurs due to production of an abnormal protein (BCR-ABL) in cells caused by a genetic abnormality (translocation of chromosome 9 and 22). For example, as the probe element X and the probe element Y of the measuring probe 1, a reagent for detecting tyrosine kinase activity of BCR-ABL is used. This reagent is composed of a substrate protein that is to be phosphorylated or its peptide fragment having a site to be phosphorylated by BCR-ABL, each of which is modified with two or more kinds of molecules capable of FRET occurrence. This reagent is linked to, for example, a fluorescent protein selected from the group consisting of GFP, eGFP, YFP, CFP, and DsRed and variants thereof. Screening of a tyrosine kinase inhibitor as the test object 5 can be efficiently performed by judging the presence or absence of FRET by the FRET measurement method according to this embodiment using this reagent. Such a reagent is described in JP 2009-278942 A.

The FRET measurement device and FRET measurement method according to the present invention have been described above in detail, but the present invention is not limited to the above embodiment and examples, and it should be understood that various changes and modifications may be made without departing from the scope of the present invention.

### REFERENCE SIGNS LIST

1 Measuring probe
2 Donor fluorescent substance
3 Acceptor fluorescent substance
4, 5 Test object
10 Flow cytometer
20 Conduit
22 Collection container
30 Light source unit
40, 50 Light-receiving unit
51 Lens system
52, 57 Dichroic mirror
53, 54, 58 Band-pass filter
55, 56, 59 Photoelectric converter
100 Control and processing unit
110 Signal generating unit
112 Oscillator
114 Powder splitter
116, 118 Amplifier
120 Signal processing unit
122, 123, 124, 125 Amplifier
126 Phase difference detector
128 Low-pass filter
130 Controller
134 Amplifier
136 A/D converter
138 System controller
150 Analyzing device
152 CPU
154 Memory
156 Input-output port
160 Parameter calculating unit
162 Judgment unit
200 Display
X, Y Probe element

1. A FRET measurement device comprising:
a conduit through which a sample flows, the sample comprising: a FRET probe that comprises a probe element X labeled with a donor fluorescent substance and a probe element Y labeled with an acceptor fluorescent substance and enables FRET to occur when the probe element X and the probe element Y approach to each other or bind together; and a test object about which it is unknown whether or not it has an approaching/binding property of allowing the probe element X and the probe element Y to approach to each other or bind together or a separating property of separating the probe element X and the probe element Y that are in a state where they adjoin each other or bind together;
a light source unit configured to emit, toward the conduit, laser light whose intensity is modulated using a modulation signal;
a light-receiving unit configured to receive fluorescence emitted from the FRET probe in the sample by irradiation with the intensity-modulated laser light and outputs a fluorescent signal;
a fluorescence calculating unit configured to calculate, using the fluorescent signal and the modulation signal, a fluorescence lifetime τₛₐₘₚₗₑ of donor fluorescence emitted from the donor fluorescent substance, and further to calculate, using the fluorescent signal, a ratio Rₛₐₘₚₗₑ of fluorescence intensity of acceptor fluorescence emitted from the acceptor fluorescent substance of the FRET probe to fluorescence intensity of donor fluorescence emitted from the donor fluorescent substance so that a plurality of sets of the fluorescence lifetime τₛₐₘₚₗₑ and the ratio Rₛₐₘₚₗₑ are calculated; and
a judgment unit configured to judge whether or not the test object has the approaching/binding property or the separating property, using the sets of the fluorescence lifetime τₛₐₘₚₗₑ and the ratio Rₛₐₘₚₗₑ.

2. The FRET measurement device according to claim 1, wherein the judgment unit is configured to: set previously a first range in which the fluorescence lifetime τₛₐₘₚₗₑ and the ratio Rₛₐₘₚₗₑ can take values when the FRET occurs and a second range in which the fluorescence lifetime τₛₐₘₚₗₑ and the ratio Rₛₐₘₚₗₑ can take values when the FRET does not occur; extract a first set group contained in the first range from all the sets to determine a first ratio of a number of the sets of the extracted first set group to a number of all the sets; extract a second set group contained in the second range to determine a second ratio of a number of the sets of the extracted second set group to a number of all the sets;
judge, using the first ratio and the second ratio, presence or absence of occurrence of the FRET; and judge whether or not the test object has the approaching/binding property or the separating property.

3. The FRET measurement device according to claim 2, wherein the judgment unit is configured to: set the first range by determining a plurality of sets of a fluorescence lifetime τ_{FRET} of donor fluorescence and a ratio R_{FRET} of fluorescence intensity of acceptor fluorescence to fluorescence intensity of donor fluorescence, the fluorescence lifetime τ_{FRET} and the ratio R_{FRET} being measured through the conduit, the light source unit, the light-receiving unit, and the judgment unit, by using a positive control sample which contains the FRET probe whose probe element X and probe element Y that are allowed to approach to each other or bind together; and
set the second range by determining a plurality of sets of a fluorescence lifetime τ_{NON-FRET} of donor fluorescence and a ratio R_{NON-FRET} of fluorescence intensity of acceptor fluorescence to fluorescence intensity of donor fluorescence, the fluorescence lifetime τ_{NON-FRET} and the ratio R_{NON-FRET} being measured, through the conduit, the light source unit, the light-receiving unit, and the judgment unit, by using a negative control sample which contains the FRET probe whose probe element X and probe element Y are not allowed to approach to each other or bind together.

4. The FRET measurement device according to claim 3, wherein the judgment unit is configured to:
set the first range based on a regression line or regression curve showing that the ratio R_{FRET} increases as the fluorescence lifetime τ_{FRET} decreases, the regression line or regression curve being determined by performing a regression analysis or a principal component analysis on the sets of the fluorescence lifetime τ_{FRET} and the ratio R_{FRET}; and
set the second range based on two averages, one of which is an average of the fluorescence lifetime τ_{NON-FRET} of the sets and the other of which is an average of the ratio R_{NON-FRET} Of the sets.

5. The FRET measurement device according to claim 4, wherein the judgment unit is configured to: determine a weighting coefficient for each plotted point of the fluorescence lifetime τₛₐₘₚₗₑ and the ratio Rₛₐₘₚₗₑ contained in the first set group on a scatter diagram whose horizontal axis and vertical axis represent the fluorescence lifetime τ_{FRET} and the ratio R_{FRET}, a value of the weighting coefficient increasing as a reciprocal of a shortest distance from each plotted position of the fluorescence lifetime τₛₐₘₚₗₑ and the ratio Rₛₐₘₚₗₑ contained in the first set group to the regression line or regression curve increases; and use a sum of values of the determined weighting coefficient as the number of the sets of the first set group.

6. The FRET measurement device according to claim 2, wherein the sets of the fluorescence lifetime τₛₐₘₚₗₑ and the ratio Rₛₐₘₚₗₑ which are used for the property judgment are information selected prior to the judgment based on the fluorescence intensity of donor fluorescence and the fluorescence intensity of acceptor fluorescence.

7. The FRET measurement device according to claim 2, wherein the FRET probe is incorporated into biological cells, and wherein, when receiving the fluorescence emitted from the FRET probe incorporated into the biological cells, the light-receiving unit measures side-scattered light and forward-scattered light of the laser light scattered by the FRET probe to judge whether or not the biological cells incorporating the FRET probe are living cells based on a measurement result of the side-scattered light and the forward-scattered light so that only a plurality of sets of the fluorescence lifetime τₛₐₘₚₗₑ and the ratio Rₛₐₘₚₗₑ obtained from fluorescence emitted from the living cells are used for the property judgment.

8. The FRET measurement device according to claim 2, wherein the judgment unit is configured to:
determine a plurality of quotients obtained by dividing the fluorescence intensity of donor fluorescence by the fluorescence lifetime τₛₐₘₚₗₑ of donor fluorescence to obtain a distribution of the quotients; and use, for the property judgment, a plurality of sets of the ratio Rₛₐₘₚₗₑ and the fluorescence lifetime τₛₐₘₚₗₑ determined when the quotients are contained in a preset range whose center is an average of the quotients in the distribution.

9. A FRET measurement method using a device comprising a conduit, a light source unit, a light-receiving unit, a fluorescence parameter calculating unit, and a judgment unit, the method comprising the steps of:
flowing, through the conduit, a sample comprising: a FRET probe that comprises a probe element X labeled with a donor fluorescent substance and a probe element Y labeled with an acceptor fluorescent substance and enables FRET to occur when the probe element X and the probe element Y approach to each other or bind together; and a test object about which it is unknown whether or not it has an approaching/binding property of allowing the probe element X and the probe element Y to approach to each other or bind together or a separating property of separating from each other the probe element X and the probe element Y that are in a state where they adjoin each other or bind together;
causing the light source unit to emit laser light whose intensity is modulated using a modulation signal toward the conduit;
causing the light-receiving unit to receive fluorescence emitted from the FRET probe in the sample by irradiation with the intensity-modulated laser light and output a fluorescent signal;
causing the fluorescence parameter calculating unit to calculate, using the fluorescent signal and the modulation signal, a fluorescence lifetime τₛₐₘₚₗₑ of donor fluorescence emitted from the donor fluorescent substance and calculate, using the fluorescent signal, a ratio Rₛₐₘₚₗₑ of fluorescence intensity of acceptor fluorescence emitted from the acceptor fluorescent substance of the FRET probe to fluorescence intensity of donor fluorescence emitted from the donor fluorescent substance so that a plurality of sets of the fluorescence lifetime τₛₐₘₚₗₑ and the ratio Rₛₐₘₚₗₑ are calculated; and
causing the judgment unit to judge, using the sets of the fluorescence lifetime τₛₐₘₚₗₑ and the ratio Rₛₐₘₚₗₑ, whether or not the test object has the approaching/binding property or the separating property.

10. The FRET measurement method according to claim 9, wherein the property judging step comprises:
a step in which the judgment unit previously sets a first range in which the fluorescence lifetime τₛₐₘₚₗₑ and the ratio Rₛₐₘₚₗₑ can take values when the FRET occurs and a second range in which the fluorescence lifetime τₛₐₘₚₗₑ and the ratio Rₛₐₘₚₗₑ can take values when the FRET does not occur, and extracts a first set group contained in the first range from all the sets of the fluorescence lifetime τₛₐₘₚₗₑ and the ratio Rₛₐₘₚₗₑ to determine a first ratio of a number of the sets of the extracted first set group to a number of all the sets;
a step in which the judgment unit extracts a second set group contained in the second range to determine a second ratio of a number of the sets of the extracted second set group to a number of all the sets; and
a step in which the judgment unit judges, using the first ratio and the second ratio, presence or absence of occurrence of the FRET to judge whether or not the test object has the approaching/binding property or the separating property.

11. The FRET measurement method according to claim 10, wherein the first range is set by causing the judgment unit to determine a plurality of sets of a fluorescence lifetime τ_{FRET} of donor fluorescence and a ratio R_{FRET} of fluorescence intensity of acceptor fluorescence to fluorescence intensity of donor fluorescence, the fluorescence lifetime τ_{FRET} and the ratio R_{FRET} being measured, through the conduit, the light source unit, the light-receiving unit, and the judgment unit, by using a positive control sample, which contains the FRET probe whose probe element X and probe element Y are allowed to approach or bind together, and
the second range is set by determining a plurality of sets of a fluorescence lifetime τ_{NON-FRET} of donor fluorescence and a ratio R_{NON-FRET} of fluorescence intensity of acceptor fluorescence to fluorescence intensity of donor fluorescence, the fluorescence lifetime τ_{NON-FRET} and the ratio R_{NON-FRET} being measured, through the conduit, the light source unit, the light-receiving unit, and the judgment unit, by using a negative control sample which contains the FRET probe whose probe element X and probe element Y are not allowed to approach to each other or bind together.

12. The FRET measurement method according to claim 11, wherein when the first range is set, the judgment unit performs a regression analysis or a principal component analysis on the sets of the fluorescence lifetime τ_{FRET} and the ratio R_{FRET} to determine a regression line or regression curve showing that the ratio R_{FRET} increases as the fluorescence lifetime τ_{FRET} decreases, and sets the first range based on the regression line or the regression curve, and
when the second range is set, the judgment unit determines an average of the fluorescence lifetime τ_{NON-FRET} of the sets and an average of the ratio R_{NON-FRET} of the sets, and sets the second range based on the averages.

13. The FRET measurement method according to claim 9, wherein the sets of the fluorescence lifetime τₛₐₘₚₗₑ and the ratio Rₛₐₘₚₗₑ used by the judgment unit for the property judgment are information selected prior to the judgment based on the fluorescence intensity of donor fluorescence and the fluorescence intensity of acceptor fluorescence.
